(19) United States
(12) Patent Application Publication
(10) Pub. No.: US 2007/0122531 A1
(43) Pub. Date: May 31, 2007

(54) Methods for Selecting a Pet-Appropriate Product

(75) Inventors: Therese M. Considine, Lake Zurich, IL (US); Patrick Roy Brown, Frisco, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wellmark International, Schaumberg, IL (US)

(21) Appl. No.: 11/550,769

(22) Filed: Oct. 18, 2006

Related U.S. Application Data
(63) Continuation-in-part of application No. 29/237,684, filed on Sep. 1, 2005.
Application No. 29/237,684 is a continuation-in-part of application No. 29/237,686, filed on Sep. 1, 2005.

(51) Int. Cl. A23B 7/148

(52) U.S. Cl. 426/106

(57) ABSTRACT

The present invention provides methods for selecting pet-appropriate products such as pest control products by enabling the contents of an animal product package to be distinguished from another animal product package. The methods comprise providing an animal product package, wherein the animal product package is shaped characteristically of the animal, and enabling the contents of the package to be distinguished based upon the characteristic shape. As a result, the methods of the present invention advantageously reduce consumer confusion and error when choosing products for their pets which may cause harm or death if intended for use on another species.

### CROSS-REFERENCES TO RELATED APPLICATIONS

This application is a Continuation-in-Part of U.S. Design Application Nos. 29/237,684 and 29/237,686, filed Sep. 1, 2005, the disclosures of which are hereby incorporated by reference in their entirety for all purposes.

### BACKGROUND OF THE INVENTION

Fleas can be a major problem for cat owners. Not only are these tiny creatures a nuisance, they are also the cause of many diseases such as flea anemia, flea bite dermatitis, and tapeworm infestation. Therefore, strict flea control is a necessary step in the health care of any cat. While there are many safe insecticide products available for use on cats, caution must be used as cats are generally more sensitive than dogs to most insecticides. For example, over-the-counter products containing about 45-60% permethrin have a good range of safety when used on dogs, but even a few drops of concentrated permethrin can be lethal to cats. However, many insecticide products intended solely for use on cats are packaged similarly to those products indicated for use only on dogs. Additionally, consumers often neglect to read the various warning labels, such as “for use on dogs only” on the packages of insecticide products intended solely for use on dogs, and apply such products on cats. As a result, there is a need in the art for methods of selecting products such as insecticides that are appropriate for a particular animal species. The present invention satisfies this and other needs.

### BRIEF SUMMARY OF THE INVENTION

The present invention provides methods for selecting pet-appropriate products such as pest control products by enabling the contents of an animal product package to be distinguished from another animal product package. The methods comprise providing an animal product package, wherein the animal product package is shaped characteristically of the animal, and enabling the contents of the package to be distinguished based upon the characteristic shape. As a result, the methods of the present invention advantageously reduce consumer confusion and error when choosing products for their pets which may cause harm or death if intended for use on another species.

Other objects, features, and advantages of the present invention will be apparent to one of skill in the art from the following detailed description and figures.

### BRIEF DESCRIPTION OF THE DRAWINGS

FIG. 1 shows a top, front view of an animal product package shaped characteristically of a dog.

FIG. 2 shows a top, front view of four animal product packages shaped characteristically of a dog arranged side by side in a single pack with perforations between each package.

FIG. 3 shows a perspective view of an animal product package shaped characteristically of a dog.

FIG. 4 shows a perspective view of four animal product packages shaped characteristically of a dog arranged side by side in a single pack.

FIG. 5 shows a top, front view of four animal product packages shaped characteristically of a cat arranged side by side in a single pack.

FIG. 6 shows a side view of the single pack of FIG. 5.

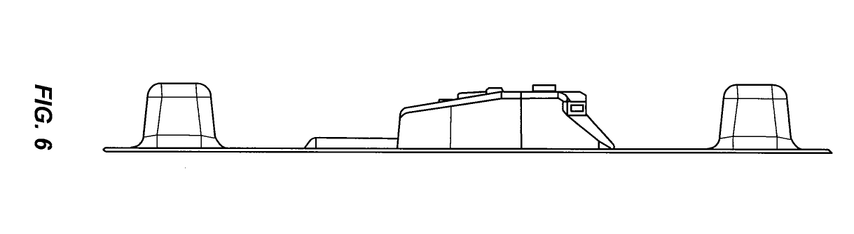

FIG. 7 shows a perspective view of an animal product package shaped characteristically of a cat.

FIG. 8 shows a perspective view of four animal product packages shaped characteristically of a cat arranged side by side in a single pack.

FIG. 9 shows a front view of an animal product dispenser shaped characteristically of a cat.

### DETAILED DESCRIPTION OF THE INVENTION

### I. Introduction

Cats can become extremely sick and even die if their owners treat them with flea control products intended for dogs only. While flea control products are often packaged similarly, the active ingredients can vary greatly, especially among popular “spot-on” products in which a small amount of liquid is applied directly to the animal's skin. A common chemical in such products is permethrin, which can be toxic to cats. In flea control products made for dogs, permethrin is usually present at a level of about 45-60%. By contrast, flea control sprays intended for cats contain a much lower concentration of permethrin, often about 2%. When cats are given flea control products intended for dogs, they quickly develop symptoms of permethrin toxicity such as excitability, twitching, and seizures. Without prompt and proper treatment, the fatality rate of overexposure to permethrin is very high. Although proper treatment by a veterinarian may prevent death, cats that survive such poisoning may not fully recover from the effects of permethrin toxicity and have, for example, permanent nerve damage. In addition, treatment in the form of emergency veterinarian and boarding services may cost the owner thousands of dollars.

The present invention provides methods for selecting pet-appropriate products such as pest control products by enabling the contents of an animal product package to be distinguished from another animal product package. In particular, the methods described herein can decrease the number of permethrin-related illnesses or deaths in cats by providing a flea control product package having a shape characteristic of a cat that enables it to be distinguished from a flea control product intended for dogs only. As a result, the methods of the present invention advantageously reduce consumer confusion and error when choosing products for their pets which may cause harm or death if intended for use on another species.

### II. Description of the Embodiments

In one aspect, the present invention provides a method for enabling the contents of an animal product package to be distinguished from another animal product package, the method comprising:
providing an animal product package, wherein the animal product package is shaped characteristically of the animal; and
enabling the contents of the package to be distinguished based upon the characteristic shape.

The animal product package is typically shaped characteristically of an animal such as a pet or a livestock animal. As used herein, the term “shaped characteristically of an animal” refers to the form or structure of a product package for a particular animal species which enables it to be distinguished from other animal species. For example, the product package can take the form of an animal's physical features (e.g., a dog's face) or resemble an object which a consumer would associate with that animal (e.g., a dog bone). In certain instances, the animal product package is shaped characteristically of a pet such as a dog, a cat, a horse, a rabbit, a guinea pig, a hamster, a gerbil, a ferret, a bird, or a mouse. In certain other instances, the animal product package is shaped characteristically of a livestock animal such as a cow, a sheep, a pig, a goat, a chicken, or a turkey. Preferably, the animal product package is shaped characteristically of a dog, a cat, or a horse. In some embodiments, the animal product package further includes an audio cue characteristic of the animal.

Examples of shapes characteristic of a dog suitable for use in the packaging of dog-appropriate products include, but are not limited to, a dog's toy (e.g., a bone, a Frisbee, a ball, etc.), a dog's face, head, and/or body (e.g., front view, side view, etc.), a dog's leash or collar, a dog's paw print, or any other visual cue which can be used to distinguish a dog from other animal species. In certain embodiments, the packaging of dog-appropriate products further includes an audio cue characteristic of a dog such as a bark or a growl, e.g., when the package is first opened or when pressure is applied to the package. Preferably, the characteristic shape of the animal product package enables consumers to distinguish a dog product from a cat product. As a non-limiting example, pest control products intended solely for use on dogs can be dispensed from bone-shaped packages (see, Example 1).

Non-limiting examples of shapes characteristic of a cat suitable for use in the packaging of cat-appropriate products include a cat's face, head, and/or body (e.g., front view, side view, etc.), a cat's toy (e.g., a ball of yam, a toy mouse or bird, etc.), a cat's paw print, or any other visual cue which can be used to distinguish a cat from other animal species. In certain embodiments, the packaging of cat-appropriate products further includes an audio cue characteristic of a cat such as a meow or a purr, e.g., when the package is first opened or when pressure is applied to the package. Preferably, the characteristic shape of the animal product package enables consumers to distinguish a cat product from a dog product. As a non-limiting example, pest control products intended solely for use on cats can be dispensed from packages shaped like a cat's face (see, Example 2).

Examples of shapes characteristic of a horse suitable for use in the packaging of horse-appropriate products include, but are not limited to, a horse's face, head, mane, and/or body (e.g., front view, side view, etc.), a horseshoe, or any other visual cue which can be used to distinguish a horse from other animal species. In some embodiments, the packaging of horse-appropriate products further includes an audio cue characteristic of a horse such as a neigh, e.g., when the package is first opened or when pressure is applied to the package. Preferably, the characteristic shape of the animal product package enables consumers to distinguish a horse product from a product intended for another animal. As a non-limiting example, pest control products intended solely for use on horses can be dispensed from horseshoe-shaped packages.

The contents of the animal product package can comprise an animal product such as, for example, a pesticide, a food or feed, a grooming product, a supplement, a drug or pharmaceutical, an animal health care product, or a give-away item. Preferably, the animal product is a pesticide.

In some embodiments, the pesticide is an insecticide. Suitable insecticides for use in the present invention include, but are not limited to, insect growth regulators (IGRs) and adulticides. Examples of IGRs include chitin synthesis inhibitors, juvenile hormone mimics, juvenile hormones, molting hormone agonists, molting hormones, molting inhibitors, precocenes, unclassified insect growth regulators, and mixtures thereof. Preferred IGRs include, for example, methoprene, hydroprene, lufenuron, kinoprene, fenoxycarb, pyriproxifen, cyromazine, diflubenzuron, novaluron, and mixtures thereof. Examples of adulticides include organophosphates, carbamates, pyrethroids, neonicotinoid insecticides, spinosyn, and the like. Preferred adulticides include, for example, permethrin, pyrethrin, tetrachlorvinphos, and mixtures thereof. Additional IGRs and adulticides that are suitable for use as animal products in the animal product packages of the present invention are described below.

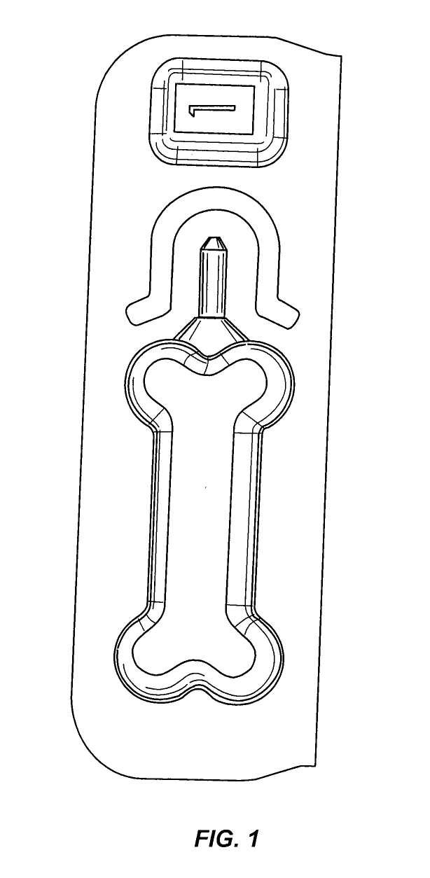

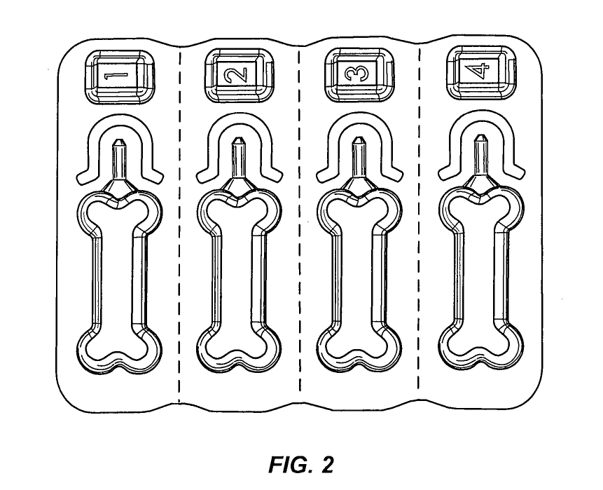

Although not being limited to any certain shape, design or geometry, in certain embodiments, the animal product package comprises a compartment having the desired characteristic shape, wherein the compartment contains an animal product such as a pesticide formulation (see, e.g., FIGS. 1, 3, and 7). In some instances, a plurality of two, three, four, or more of these animal product packages are arranged side by side in a single pack (see, e.g., FIGS. 2, 4, 5, and 8). Typically, the single pack is a blister pack. The blister pack can be made according to any technique known to one skilled in the art. For example, the blister pack can be manufactured as a sheet composed of plastic or another elastomeric material having a plurality of hollow cavities molded into the desired characteristic shape, wherein the cavities contain the animal product and are sealed with a backing to form blister compartments arranged side by side on the sheet. The blister pack can also include perforations between each of the animal product packages to separate them for individual use (see, e.g., FIG. 2). Each package in the blister pack can additionally contain a number marking to indicate the order in which the packages are to be used (see, e.g., FIG. 2). As illustrated in FIG. 1, the animal product can be dispensed from each package by first snapping the “Q” shaped portion of the package back to expose the applicator tip and then applying pressure to the blister compartment to release the product.

A product package of the invention is not limited to any certain size. In one instance, the individual animal product package is typically from about 25 mm to about 50 mm in length (e.g., about 25, 30, 35, 40, 45, or 50 mm) and from about 10 mm to about 40 mm in width (e.g., about 10, 15, 20, 25, 30, 35, or 40 mm). The compartment containing the animal product is usually from about 2 mm to about 25 mm in height (e.g., about 2, 3, 4, 5, 6, 7, 8, 9, 10, 15, 20, or 25 mm). In instances where four animal product packages are arranged side by side in a single pack such as a blister pack, the pack is typically from about 100 mm to about 200 mm in length (e.g., about 100, 110, 120, 130, 140, 150, 160, 170, 180, 190, or 200 mm) and from about 50 mm to about 150 mm in width (e.g., about 50, 60, 70, 80, 90, 100, 110, 120, 130, 140, or 150 mm).

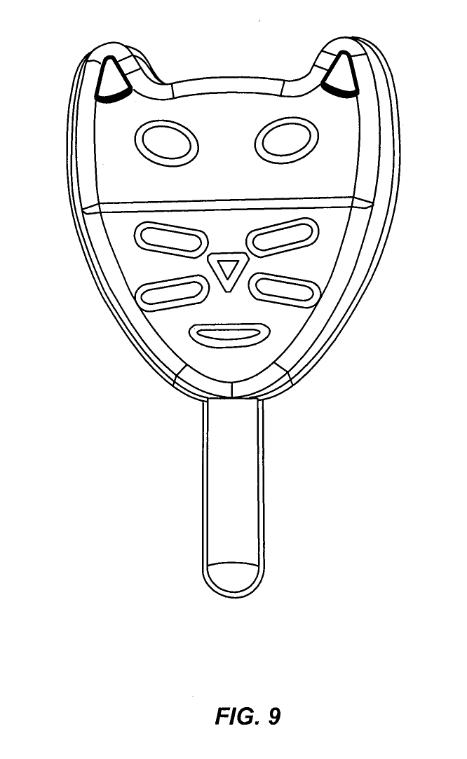

In certain other embodiments, the animal product package is a blister pack comprising a plurality of compartments containing animal product dispensers having the desired characteristic shape, wherein the dispensers are individually removed from the blister pack by pushing them through a rupturable backing. An example of a cat-shaped product dispenser having an applicator tip is shown in FIG. 9. The animal product dispenser and blister pack can be made according to any technique known to one skilled in the art. For example, the animal product dispenser can be made by molding plastic or another elastomeric material into the desired characteristic shape. The molded dispenser can then be filled with an animal product such as a pesticide formulation and dispensed from the applicator tip by applying pressure thereto. The blister pack containing the animal product dispensers can be manufactured, for instance, as a first sheet having a plurality of apertures, each aperture defining an opening having an area large enough for the individual animal product dispenser to pass through, and a second sheet overlapping a portion of the first sheet, wherein the second sheet forms a plurality of hollow cavities that are sealed with a rupturable backing to form blister compartments arranged in a pattern on the sheet. One skilled in the art will know of additional techniques for making blister packs which are suitable for use in the methods of the present invention.

Again, a product package of the invention is not limited to any certain size. In certain instances, each individual animal product dispenser is typically from about 20 mm to about 100 mm in length (e.g., about 20, 30, 40, 50, 60, 70, 80, 90, or 100 mm), from about 10 mm to about 40 mm in width (e.g., about 10, 15, 20, 25, 30, 35, or 40 mm), and from about 2 mm to about 25 mm in height (e.g., about 2, 3, 4, 5, 6, 7, 8, 9, 10, 15, 20, or 25 mm).

### III. Pesticides

Various pesticides are suitable for use in the present invention. The term “pesticide” as employed herein is intended to include any active material used for the control of unwanted pests which infest an animal, such as fleas, ticks, mosquitoes, and the like. Suitable pesticides include, without limitation, insecticides, biocides, herbicides, fungicides, insect repellants, antimicrobials, and other materials utilizable on an animal such as a pet (e.g., cat, dog, horse, etc.) to prevent, destroy, repel, and/or reduce pests.

In some embodiments, the pesticide is an insecticide such as an insect growth regulator (IGR). Insect growth regulators, including juvenile hormones, are well known for their use and efficacy in controlling or eliminating insect infestation in humans, in animals, and in both residential and industrial environments. Many types of insects are controllable by insect growth regulators, including, without limitation, fleas, ticks, mosquitoes, flies (e.g., face flies, house flies, stable flies, and horn flies), flour beetles, cigarette beetles, and cockroaches.

The insect growth regulators vary widely in chemical composition, with two of the more prominent classes comprising 2,4-dienoic acids and phenoxyphenoxy compounds, e.g., phenoxyphenoxyalkoxyheterocyclics. Benzoylureas and triazine derivatives are also suitable for use in the present invention as insect growth regulators. Examples of 2,4-dienoic acids and related compounds include, without limitation, methoprene, hydroprene, kenoprene, neotenin, and epiphenonane. As used herein, “methoprene” includes R-methoprene, S-methoprene, and all mixtures of R- and S-methoprene. S-methoprene is the preferred methoprene. Examples of phenoxyphenoxy compounds include, without limitation, fenoxycarb and pyriproxyfen. Examples of benzoylureas include, without limitation, lufenuron, diflubenzuron, terflubenzuron, triflumaron, hexaflumaron, and flucycloxuron. An example of a triazine derivative is 2-cyclopropylamino-4,6-bis(dimethylamino)-s-triazine.

Suitable IGRs for use in the present invention include, without limitation, chitin synthesis inhibitors such as bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron, and triflumuron; juvenile hormone mimics such as epofenonane, fenoxycarb, hydroprene, kinoprene, methoprene, pyriproxyfen, and triprene; juvenile hormones such as juvenile hormone I, juvenile hormone II, and juvenile hormone III; molting hormone agonists such as chromafenozide, halofenozide, methoxyfenozide, and tebufenozide; molting hormones such as α-ecdysone and ecdysterone; molting inhibitors such as diofenolan; precocenes such as precocene I, precocene II, and precocene III; unclassified insect growth regulators such as dicyclanil; other IGRs; and mixtures thereof.

In other embodiments, the pesticide is an insecticide such as an adulticide. The term “adulticide” as used herein refers to a pesticide designed to kill adult insects. Suitable adulticides for use in the present invention include, for example, pyrethroids, organophosphates, carbamates, neonicotinoid insecticides, spinosyn, and the like. Non-limiting examples of pyrethroid compounds include allethrin, bifenthrin, bioresmethrin, cyfluthrin, cyhalothrin, cypermethrin, deltamethrin, esfenvalerate, fenvalerate, flumethrin, permethrin, pyrethrin, resmethrin, and their synergists (e.g., piperonyl butoxide). Examples of organophosphate compounds include, without limitation, acephate, azinphosmethyl, bensulide, cadusafos, chlorethoxyfos, chlorpyrifos, chlorpyrifos methyl, chlorthiophos, coumaphos, dialiflor, diazinon, dichlorvos, dicrotophos, dimethoate, dioxathion, disulfoton, ethion, ethoprop, ethyl parathion, fenamiphos, fenitrothion, fenthion, fonofos, isazophos methyl, isofenphos, malathion, methamidophos, methidathion, methyl parathion, mevinphos, monocrotophos, naled, oxydemeton methyl, phorate, phosalone, phosmet, phosphamidon, phostebupirim, pirimiphos methyl, profenofos, propetamphos, sulfotepp, suiprofos, temephos, terbufos, tetrachlorvinphos, tribufos, and trichlorfon. Examples of carbamate compounds include, without limitation, aldicarb, bendiocarb, carbaryl, carbofuron, fenoxycarb, methomyl, pirimicarb, and propoxur. Examples of neonicotinoid insecticides include, without limitation, imidacloprid, acetamiprid, nithiazine, and thiomethoxam. One skilled in the art will know of additional adulticides suitable for use in the present invention.

The pesticide can be formulated as a solid, semi-solid, or fluid formulation such as a shampoo, a spray, a topical spot-on, a mousse, a foam, a solution, a suspension, or a powder. The amount of pesticide in the formulation can range from about 0.001% w/w to about 99% w/w, e.g, from about 0.01% w/w to about 75% w/w, from about 0.01% w/w to about 50% w/w, from about 0.01% w/w to about 20% w/w, or from about 0.01% w/w to about 10% w/w. The pesticide formulation is typically dispensed from an animal product package having a shape characteristic of the animal for which the pesticide is suitable for use. For example, pesticides such as organophosphates and pyrethroids, which are useful for pest control on dogs but may be lethal to cats, can be packaged in an animal product package having a shape characteristic of a dog (e.g., a bone, a dog's face, etc.). Similarly, pesticides such as methoprene, lufenuron, or pyriproxifen, which may be more useful for pest control on cats, can be packaged in an animal product package having a shape characteristic of a cat (e.g., a cat's face, etc.).

### IV. EXAMPLES

The following examples are offered to illustrate, but not to limit, the claimed invention.

### Example 1

### Package For Dog Products

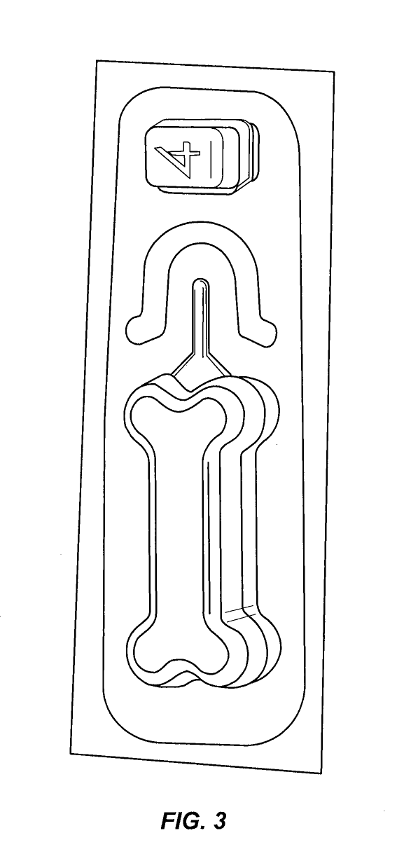

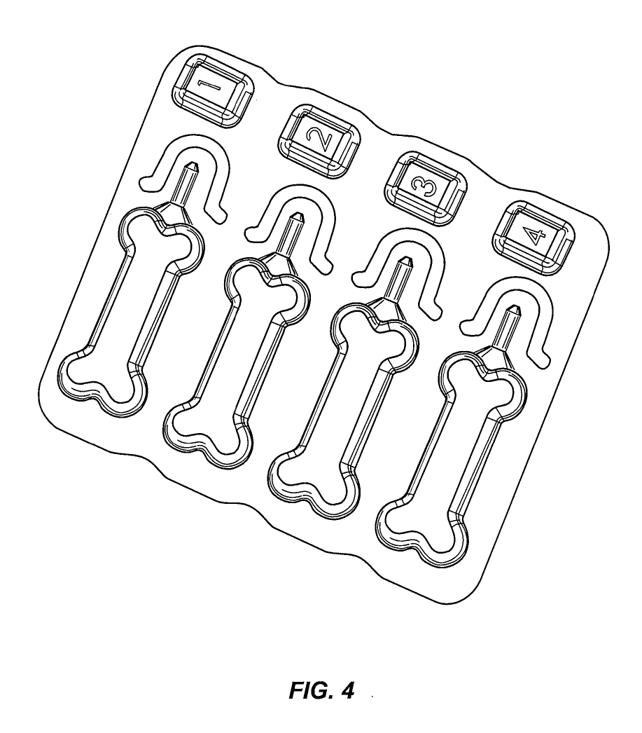

This example illustrates a bone-shaped package (FIGS. 1 and 3) and a pack of four bone-shaped packages arranged side by side (FIGS. 2 and 4) containing, for example, a pesticide formulation suitable for use only on dogs. The bone-shaped package is intended for use as a topical dispenser of a formulation such as a solid, semi-solid, or fluid formulation. One example of such a formulation is a pesticide formulation intended for control of pests such as fleas and ticks on dogs.

### Example 2

### Package For Cat Products

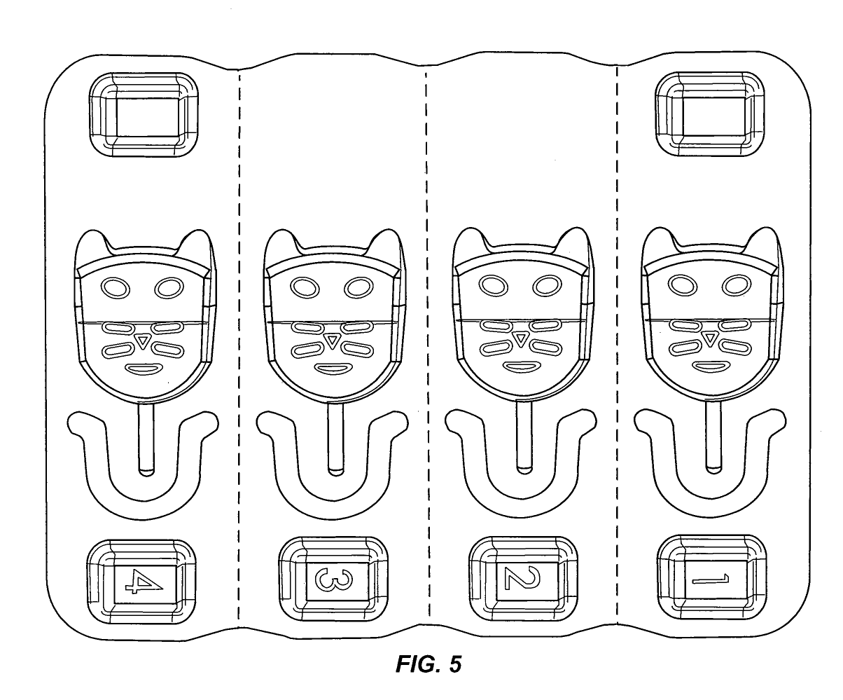

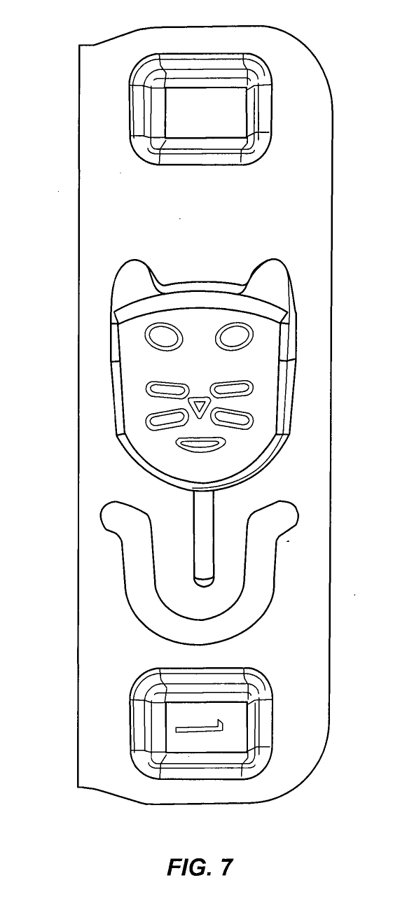

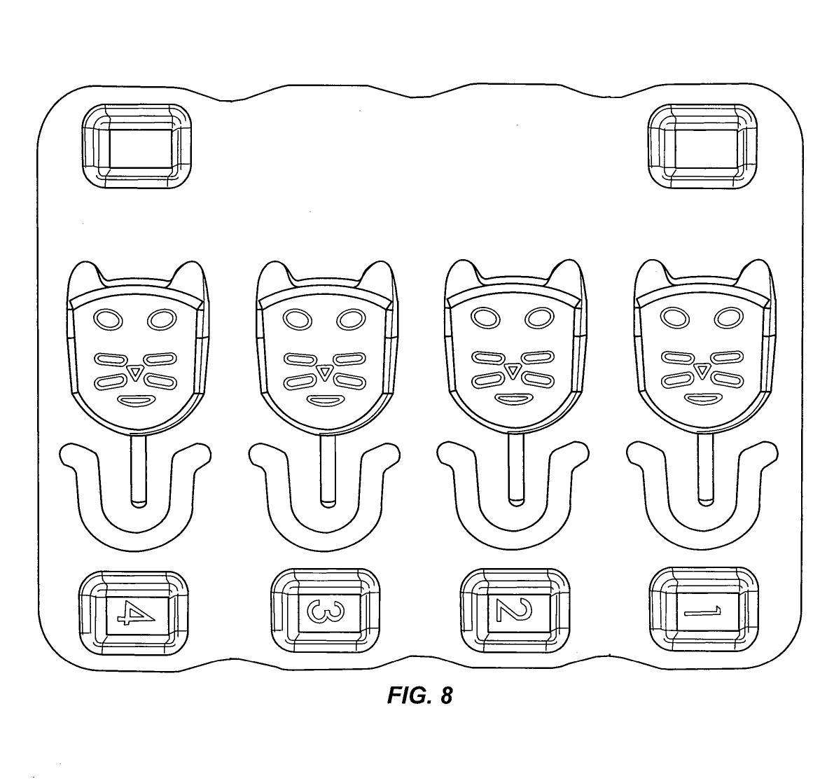

This example illustrates a package shaped like a cat's face (FIG. 7) and a pack of four cat-shaped packages arranged side by side (FIGS. 5 and 8) containing, for example, a pesticide formulation suitable for use only on cats. The cat-shaped package is intended for use as a topical dispenser of a formulation such as a solid, semi-solid, or fluid formulation. One example of such a formulation is a pesticide formulation intended for control of pests such as fleas and ticks on cats.

### Example 3

### Selecting A Cat-Appropriate Pest Control Product

This example illustrates a method for selecting a cat-appropriate pest control product by enabling the contents of a package containing a pest control product intended for cats to be distinguished from a package containing a pest control product intended for dogs. Consumers interested in purchasing pest control products for their cats either at a store or online often encounter similar products intended for dogs only. To enable consumers to distinguish between them, dog-appropriate pest control products are contained within bone-shaped packages, whereas cat-appropriate pest control products are contained within packages shaped like a cat's face. This reduces consumer confusion and error when choosing pest control products for their cats which may cause harm or death if intended for use on dogs. Consumers then purchase the appropriate pest control product for their cats by looking at the bone-shaped and cat-shaped packages and selecting the cat-shaped package.

All publications and patent applications cited in this specification are herein incorporated by reference as if each individual publication or patent application were specifically and individually indicated to be incorporated by reference. Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. A method for enabling the contents of an animal product package to be distinguished from another animal product package, said method comprising:
providing an animal product package, wherein said animal product package is shaped characteristically of said animal; and
enabling the contents of said package to be distinguished based upon said characteristic shape.

2. The method of claim 1, wherein said animal product package is shaped characteristically of an animal selected from the group consisting of a dog, a cat, a horse, a rabbit, a guinea pig, a hamster, a gerbil, a ferret, a bird, and a mouse.

3. The method of claim 1, wherein said animal product package is shaped characteristically of a dog.

4. The method of claim 3, wherein said characteristic shape is a bone.

5. The method of claim 3, wherein said characteristic shape is a dog's face.

6. The method of claim 3, wherein said characteristic shape of said animal product package enables distinguishing a dog product from a cat product.

7. The method of claim 1, wherein said animal product package is shaped characteristically of a cat.

8. The method of claim 7, wherein said characteristic shape is a cat's face.

9. The method of claim 7, wherein said characteristic shape of said animal product package enables distinguishing a cat product from a dog product.

10. The method of claim 1, wherein said animal product package is shaped characteristically of a horse.

11. The method of claim 10, wherein said characteristic shape is a horseshoe.

12. The method of claim 10, wherein said characteristic shape is a horse's face.

13. The method of claim 1, wherein said animal product is a member selected from a group consisting of a pesticide, a food or feed, a grooming product, a supplement, a drug or pharmaceutical, an animal health care product, and a give-away item.

14. The method of claim 1, wherein said animal product is a pesticide.

15. The method of claim 14, wherein said pesticide is an insecticide.

16. The method of claim 15, wherein said insecticide is an insect growth regulator or an adulticide.
